(19) United States
(12) Patent Application Publication
(10) Pub. No.: US 2007/0240280 A1
(43) Pub. Date: Oct. 18, 2007

(54) Movements Controlling Means

(76) Inventor: William Ernest Taylor Vallance, Buckinghamshire (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 10/555,229

(22) PCT Filed: Apr. 23, 2004
(86) PCT No.: PCT/GB04/01790

§ 371 Date: Dec. 7, 2006

(30) Foreign Application Priority Data
May 2, 2003 (GB) 0310185.4

(51) Int. Cl. E05F 5/02

(52) U.S. Cl. 16/82

(57) ABSTRACT

A movement control device for a piece of furniture comprises a twisted rod (15) and a rotary damper assembly (13). The rod is attached to one part (12) of the furniture and the damper assembly te, another part (11). The rod engages the damper assembly via a drive mechanism which translates longitudinal movement of the rod into rotary movement of a damper unit within the damper assembly. The device is thus able to provide damping for relative movements between the furniture parts.

This invention relates to movement controls, and in particular to devices for providing damped control of movable furniture parts such as lids, doors and drawers and drop-down flaps.

It is known to provide a stay for the lid of a piece of furniture such as a linen chest, which acts upon opening of the lid to hold it in an open position and which can be de-activated to allow the lid to close. Some such stays also feature a fiction mechanism, which may be adjustable, which is designed to act as a brake to stop the lid from slamming shut.

The present invention aims to improve upon existing movement controls and provides an assembly for controlling movement of a first member relative to a second member in a piece of furniture, said assembly comprising a rotary shear damper as defined herein connected to the first member, and drive means connected between the second member and the damper such that movement of the second member in at least one direction relative to the first member causes rotary movement of the damper thereby to impart a damping resistance to said movement of the second member.

By way of example, an embodiment of the invention will now be described with reference to the accompanying drawings, in which:

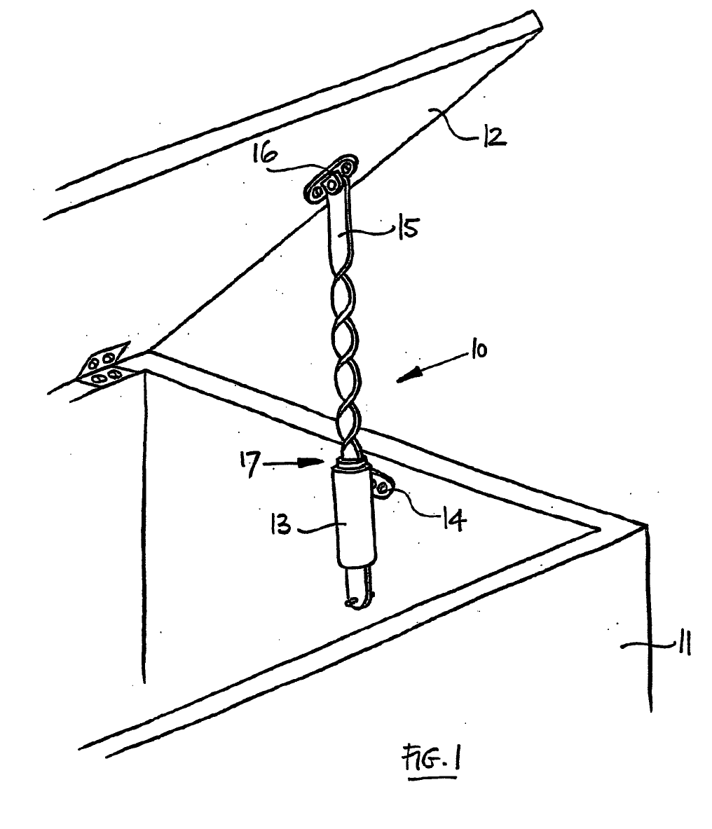

FIG. 1 illustrates a form of movement control assembly according to the invention in use on apiece of furniture, and

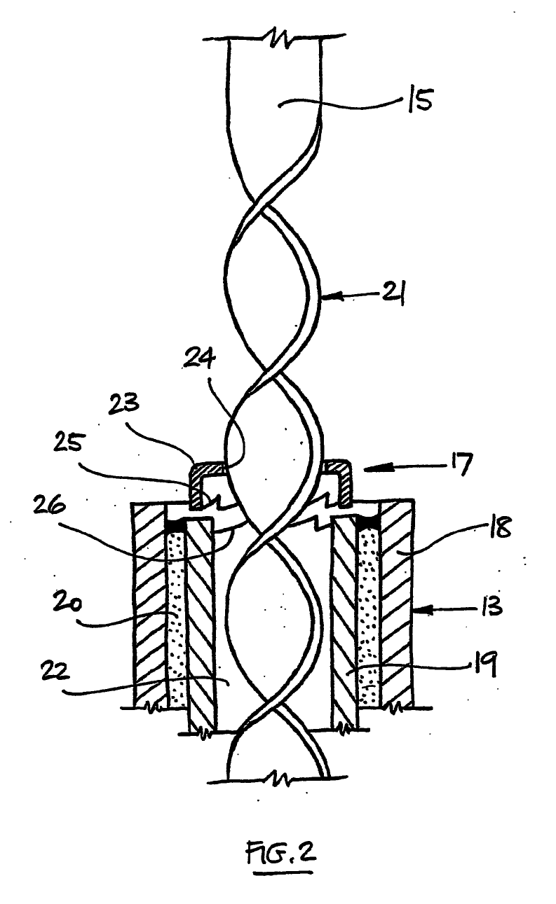

FIG. 2 is a detail of the clutched drive mechanism of the assembly of FIG. 1.

FIG. 1 shows a piece of furniture, in this case a linen chest, with a movement control assembly 10 connected between the chest 11 and its hinged lid 12. The assembly 10 comprises a damper 13 which is pivotally connected to the inside of the chest 11 by means of a suitable bracket 14, and an elongate bar 15, pivotally attached to the lid 12 by means of a suitable bracket 16. The bar is linked to the damper 13 by means of a clutched drive mechanism 17. As will be described in more detail below, movement of the bar 15 when the lid 12 closes causes rotary movement of the damper 13, which thereby imparts damping resistance to the closing movement of the lid.

A suitable damper 13 for use in such an assembly is a so-called rotary shear damper. Rotary shear dampers are known in the art and basically consist of one part which is rotatably movable relative to another, with a medium such as silicon between He two parts to absorb energy and hence provide resistance to the rotary movement, ie damping. Such dampers are available on the market in a number of different sizes and designs and these are referred to herein generally as “rotary shear dampers”.

Looking now at FIG. 2, it will be seen that the rotary shear damper 13 in this example is in the form of an outer cylindrical casing 18 in which an inner sleeve 19 is rotatably mounted, with the energy-absorbing substance held in the sealed-of annulus 20 between the two.

The elongate bar 15 here is in the form of a flat strip which has been formed with a series of helical twists 21. The bar 15 extends through the bore 22 of the inner sleeve 19 of the damper 13. The clutched drive mechanism 17 by which the bar 15 is arranged to cause rotation of the sleeve 19 comprises a collar 23. The collar 23 has a rectangular slot 24 which slidably receives the bar 15. The collar 23 and bar 15 work together as a movement converter, ie converting the essentially linear movement of the bar into rotary movement of the collar, in the manner of the mechanism of a child's spinning top. Thus, the collar 23 will be caused to rotate by the helical twists 21 in the bar 15 when the bar is moved longitudinally relative to it

The collar 23 and sleeve 19 are provided with a series of complementary opposed ramped teeth 25, 26 respectively. By this mean, in the manner of a dog clutch, rotation of the collar 23 in one direction will drive the sleeve 19 to rotate, whilst rotation of the collar in the opposite direction will not drive the sleeve to rotate. The clutched drive mechanism 17 here is arranged so that the collar 23 will be engaged to drive the sleeve 19 during closing movement of the lid 12, whilst drive is disengaged during its opening movement. By this arrangement, the assembly 10 exerts no effect on the lid 12 when it is opened, but acts to damp its movement as it closes.

It will be appreciated that the configuration of the helical twists 21 formed in the bar 15 may be varied in a number of different ways to give various different damping effects. For example, the pitch of the twists may be increased or decreased or made variable so that a given longitudinal movement of the bar 15 will produce different actuations of the damper 13. Or, the twists may be separated by a plain section, for example, so as to produce an intermittent actuation of the damper. Varying the rate and/or amount of actuation of the damper affects the damping action that it produces. The lid 12 here, for example, will tend to accelerate as it closes due to gravity and the assembly could thus be tailored to produce a steadily increasing amount of damping action to counteract this.

It will also be appreciated that by adjusting the geometry of the arrangement, ie the positioning of the pivotal mountings 14 and 16 relative to each other and to the hinge of the lid 12 itself, the same basic assembly could be used to cater for a range of different lids, in particular, lids of different size and weight.

It will be further understood that the assembly could be readily adapted to provide movement control in any number of different situations where one member is movable relative to another including, for example, doors, drawers and drop-down flaps.

The bar 15 in this embodiment is conveniently made by twisting a stand flat piece of metal It will be appreciated, however, that other designs could equally well be used for this element. For example, the element could be formed of moulded plastics with perhaps a square or star-shaped cross-sections Or, the element might have a basically circular cross-section with a helical groove formed around its circumference, with the collar having a radially extending lug to engage the groove, akin to the operating mechanism of a spiral ratchet screw driver.

It might also be desired to vary the damping action of the movement control assembly in other ways. For example, in a horizontally-binged element such as a flap for a shoe rack which opens to an angle of 45° to the vertical, it may be desired to damp movement of the flap during its last 30° of opening and during its last 15° of closing, with no damping in between. This could be achieved by a modification to the assembly shown in FIGS. 1 and 2, for example, by providing separate clutched drive mechanism 17 at either end of the damper 13 working in opposite rotational senses. The helical twists 21 in the bar 15 would then be configured and arranged so as to act with a respective collar 23 at one end of the damper 13 to produce damping during a chosen range of movement of the bar 15 in one direction, whilst the respective collar 23 at the other end of the damper 13 would produce damping during a chosen range of movement of the bar in the opposite direction.

1. An assembly for controlling movement of a first member relative to a second member in a piece of furniture, said assembly comprising a rotary shear damper as defined herein connected to the first member, and drive means connected between the second member and the damper such that movement of the second member in at least one direction relative to the first member causes rotary movement of the damper thereby to impart a damping resistance to said movement of the second member.

2. An assembly as claimed in claim 1 wherein the drive means is arranged to cause variable rotary movement of the damper.

3. An assembly as claimed in claim 1 wherein the drive means is designed to cause intermittent rotary movement of the damper.

4. An assembly as claimed in claim 1 wherein the drive means comprises a clutch mechanism whereby the drive means does not cause rotary movement of the damper during movement of the second member relative to the first member in a direction opposite to said one direction.

5. An assembly as claimed in claim 1 wherein said drive means is operable to cause rotary movement of the damper for at least a part of the movement of the second member in both said one direction and in a direction opposite thereto.

6. An assembly as claimed in claim 5 wherein the nature and/or extent of rotary movement of the damper caused by movement of the second member in said one direction is different from the nature and/or extent of the rotary movement of the damper caused by movement of the second member in said opposite direction.

7. An assembly as claimed in claim 1 wherein the drive means comprises an elongate element with a series of helical twists.

8. An assembly as claimed in claim 7 wherein the drive means further comprises a collar having a hole therethrough for slidably receiving the elongate element, the hole having a cross-section complementary to the cross-section f the elongate element so that the helical twists will cause the collar to rotate upon longitudinal movement of the elongate element relative to the collar.

9. An assembly as claimed in claim 8 wherein the clutch mechanism comprises a ramped tooth engagement between the collar and the damper.

10. A piece of furniture comprising a movement control assembly as claimed in claim 1.
